(19) United States
(12) Patent Application Publication
(10) Pub. No.: US 2020/0319709 A1
(43) Pub. Date: Oct. 8, 2020

(54) INFORMATION PROCESSING SYSTEM, OPERATION METHOD, AND OPERATION PROGRAM

(71) Applicant: FOVE, INC., San Mateo, CA (US)

(72) Inventors: Yamato KANEKO, Tokyo (JP); Lochlainn WILSON, Tokyo (JP); Yuka KOJIMA, Tokyo (JP)

(21) Appl. No.: 16/906,880

(22) Filed: Jun. 19, 2020

Related U.S. Application Data
(63) Continuation of application No. 15/663,123, filed on Jul. 28, 2017.

(30) Foreign Application Priority Data
Jul. 29, 2016 (JP) 2016-150599

(51) Int. Cl. G06F 3/01; G06F 3/0481

(52) U.S. Cl. CPC G06F 3/013; G06F 3/04817; G06F 3/017

(57) ABSTRACT

An information processing system includes: a display processing unit configured to display an image on a display unit; a detection unit configured to detect a gaze of a user viewing the image displayed on the display unit; an extraction unit configured to extract an operation signal correlated with a movement of the gaze of the user detected by the detection unit with reference to correlation data in which predetermined movements of a gaze are correlated with operation signals preset to correspond to the predetermined movements of a gaze; and an execution unit configured to execute an operation corresponding to the operation signal extracted by the extraction unit.

### BACKGROUND OF THE INVENTION

### Field of the Invention

The present invention relates to an information processing system, an operation method, and an operation program that execute an operation and more particularly to a technique of executing an operation based on gaze data of a user.

### Description of Related Art

With advances in information technology, computers have been able to be decreased in size and various information processing devices have been developed. For example, spreading of wearable computers has progressed. Features of a wearable computer include that it has a small size, can be worn by a user, and can be easily carried. For example, a wristwatch type wearable computer can be worn on a user's arm for use. For example, an eyeglass type wearable computer can be worn on a user's face for use.

A wearable computer is formed in a wearable shape. Accordingly, an input device and an output device of a wearable computer are configured to correspond to the wearable shape. A user carries out an input operation on the wearable computer while wearing it. Accordingly, an input method and an output method different from methods using operation buttons, a keyboard, a mouse, a touch panel, or a liquid crystal display as an input device and an output device of a personal computer, a mobile phone, or the like may be used.

Facilitation of operations in such a wearable computer has been studied (for example, see Japanese Unexamined Patent Application Publication No. 2003-289484 and Japanese Unexamined Patent Application Publication No. 2010-146481). In the method described in Japanese Unexamined Patent Application Publication No. 2003-289484, an operation switch disposed in a wearable computer is used to execute an operation. In the method described in Japanese Unexamined Patent Application Publication No. 2010-146481, an operation corresponding to a panel selected by a user can be executed by detecting a movement of a user's hand and selecting a virtual panel at a position at which the hand is located.

On the other hand, in an eyeglass type wearable computer, a user's field of view is covered when the user wears the wearable computer. That is, compared to normal eyeglasses, a display for displaying image data is disposed at a position of a lens of the eyeglasses and thus a user may have difficulty in viewing his or her surroundings or the surroundings may not be visible. In such circumstances, it may be difficult to operate an operation switch using a hand or to select a virtual panel by moving a hand forward and backward.

### SUMMARY OF THE INVENTION

As described above, there is a problem in improvement in operability of an information processing device.

The present invention has been made in consideration of the above-mentioned problem, and an object thereof is to provide an information processing system, an operation method, and an operation program that can improve operability in an information processing device.

According to an aspect of the present invention, there is provided an information processing system including: a display processing unit configured to display an image on a display unit; a detection unit configured to detect a gaze of a user viewing the image displayed on the display unit; an extraction unit configured to extract an operation signal correlated with a movement of the gaze of the user detected by the detection unit with reference to correlation data in which predetermined movements of a gaze are correlated with operation signals preset to correspond to the predetermined movements of a gaze; and an execution unit configured to execute an operation corresponding to the operation signal extracted by the extraction unit.

The information processing system may further include a determination unit configured to determine a predetermined movement of the gaze corresponding to the movement of the gaze of the user among the predetermined movements of the gaze included in the correlation data, and the extraction unit may extract an operation signal correlated with the predetermined movement of the gaze determined by the determination unit as the operation signal corresponding to the movement of the gaze of the user.

The image may include an icon correlated with the operation signal, the information processing system may further include a determination unit configured to determine whether the movement of the gaze of the user detected by the detection unit is a predetermined movement of a gaze which is performed while viewing the icon, and the execution unit may execute an operation corresponding to the operation signal correlated with the icon when the determination unit determines that the movement of the gaze of the user is the predetermined movement of the gaze.

The information processing system may be a head mounted display system.

According to another aspect of the present invention, there is provided an operation method including: a step of displaying an image on a display unit; a step of detecting a gaze of a user viewing the image displayed on the display unit; a step of extracting an operation signal correlated with a detected movement of the gaze of the user with reference to correlation data in which predetermined movements of a gaze are correlated with operation signals preset to correspond to the predetermined movements of a gaze; and a step of executing an operation corresponding to the extracted operation signal.

According to another aspect of the present invention, there is provided an operation program causing an information processing device to perform: a display processing function of displaying an image on a display unit; a detection function of detecting a gaze of a user viewing the image displayed on the display unit; an extraction function of extracting an operation signal correlated with a detected movement of the gaze of the user with reference to correlation data in which predetermined movements of a gaze are correlated with operation signals preset to correspond to the predetermined movements of a gaze; and an execution function of executing an operation corresponding to the extracted operation signal.

According to another aspect of the present invention, there is provided an information processing system including: a display processing unit configured to display a plurality of data groups in a display area; an acquisition unit configured to acquire gaze data of a user viewing the display area; a specification unit configured to specify a data group of interest that the user views from the gaze data acquired by the acquisition unit; and a reception unit configured to receive an operation signal which is input via an input device by the user as an operation signal for the data group of interest specified by the specification unit.

The display processing unit may display the data group of interest specified by the specification unit to be located at the center of the display area.

The display processing unit may display the data group of interest specified by the specification unit to be larger than the other data groups in the display area.

The display processing unit may display the data group of interest specified by the specification unit to be located at the forefront among the plurality of data groups in the display area.

Each data group may be a window screen including data.

The display area may be a display.

The information processing system may be a head mounted display system.

According to another aspect of the present invention, there is provided a display method including: a display step of displaying a plurality of data groups in a display area; an acquisition step of acquiring gaze data of a user viewing the display area; a specification step of specifying a data group of interest that the user views from the gaze data acquired in the acquisition step; and a reception step of receiving an operation signal which is input via an input device by the user as an operation signal for the data group of interest specified in the specification step.

According to another aspect of the present invention, there is provided a display program causing an information processing device to perform: a display function of displaying a plurality of data groups in a display area; an acquisition function of acquiring gaze data of a user viewing the display area; a specification function of specifying a data group of interest that the user views from the gaze data acquired by the acquisition function; and a reception function of receiving an operation signal which is input via an input device by the user as an operation signal for the data group of interest specified by the specification function.

According to the present invention, it is possible to operate an information processing system depending on a movement of a user's gaze.

### BRIEF DESCRIPTION OF THE DRAWINGS

FIG. 1 is a diagram illustrating the appearance of a user wearing a head mounted display according to a first embodiment;

FIG. 2 is a perspective view schematically illustrating an overview of an image display system of the head mounted display according to the first embodiment;

FIG. 3 is a diagram schematically illustrating an optical configuration of the image display system of the head mounted display according to the first embodiment;

FIG. 4 is a block diagram illustrating a configuration of the head mounted display system according to the first embodiment;

FIGS. 5A to 5D illustrate examples of movements of a user's gaze detected by the head mounted display system according to the first embodiment and FIGS. 5E to 5H illustrate examples of an operation signal corresponding thereto;

FIGS. 6A to 6C illustrate examples of correlation data which is used in the head mounted display system according to the first embodiment;

FIGS. 7A and 7B are flowcharts illustrating a routine in the head mounted display system according to the first embodiment;

FIG. 8 is a diagram schematically illustrating calibration for detecting a gaze direction in the head mounted display system according to the first embodiment;

FIG. 9 is a diagram schematically illustrating position coordinates of a user's cornea;

FIG. 10 is a block diagram illustrating a circuit configuration of a head mounted display system;

FIG. 11 is a block diagram illustrating a configuration of a head mounted display system according to a second embodiment;

FIGS. 12A to 12C illustrate display examples of data in the head mounted display system according to the second embodiment; and

FIG. 13 is a flowchart illustrating a routine in the head mounted display system according to the second embodiment.

### DETAILED DESCRIPTION OF THE INVENTION

An information processing system, an operation method, and an operation program which will be described below are for executing an operation based on gaze data of a user. An information processing system, a display method, and a display program are for changing a display mode depending on gaze data of a user. In embodiments which will be described below, it is assumed that the information processing system is a head mounted display system. However, the information processing system according to the present invention is not limited to the head mounted display system and can be embodied as various information processing systems that can detect a gaze. Hereinafter, embodiments of the present invention will be described with reference to the accompanying drawings. In the following description, like elements will be referenced by like reference signs and description thereof will not be repeated.

### First Embodiment

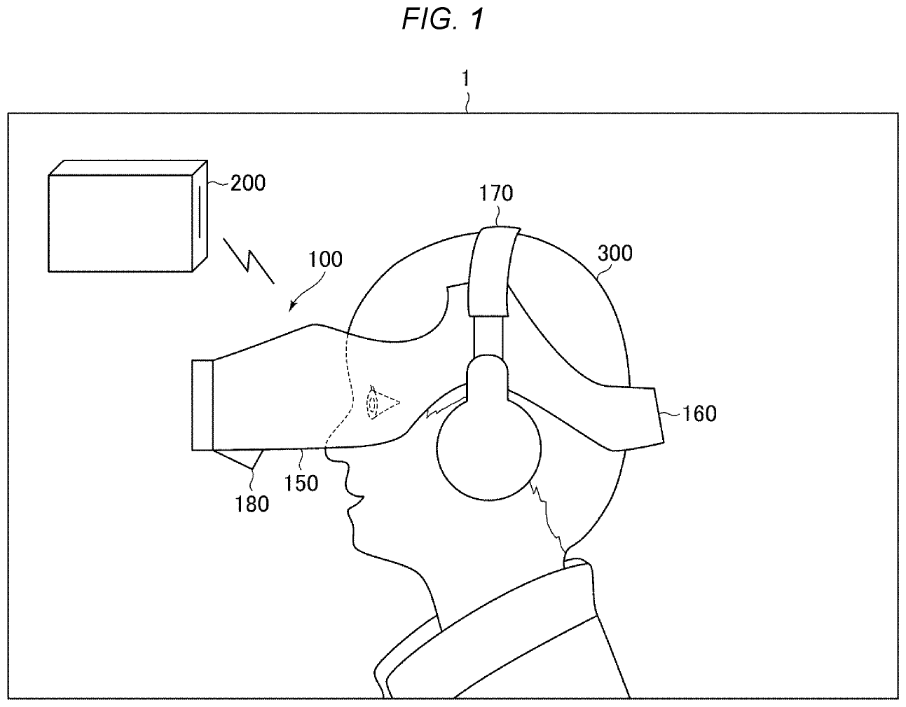

A head mounted display system according to a first embodiment functions to detect a movement of a user's gaze and to execute an operation corresponding to the movement. FIG. 1 is a diagram schematically illustrating an overview of a head mounted display system 1 according to a first embodiment. As illustrated in FIG. 1, a head mounted display 100 is mounted on the head of a user 300 for use.

A gaze detection device 200 detects a gaze direction of at least one of a right eye and a left eye of the user wearing the head mounted display 100 and specifies the user's focal point, that is, a point gazed by the user in a three-dimensional image displayed on the head mounted display. The gaze detection device 200 also functions as a video generation device that generates a video to be displayed by the head mounted display 100. For example, the gaze detection device 200 is a device capable of reproducing videos of stationary game machines, portable game machines, PCs, tablets, smartphones, phablets, video players, TVs, or the like, but the present invention is not limited thereto. The gaze detection device 200 is wirelessly or wiredly connected to the head mounted display 100. In the example illustrated in FIG. 1, the gaze detection device 200 is wirelessly connected to the head mounted display 100. The wireless connection between the gaze detection device 200 and the head mounted display 100 can be realized using a known wireless communication technique such as Wi-Fi (registered trademark) or Bluetooth (registered trademark). For example, transfer of videos between the head mounted display 100 and the gaze detection device 200 is executed according to a standard such as Miracast (registered trademark), WiGig (registered trademark), or WHDI (registered trademark). Other communication techniques may be used and, for example, acoustic communication techniques or optical transmission techniques may be used.

FIG. 1 illustrates an example in which the head mounted display 100 and the gaze detection device 200 are different devices. However, the gaze detection device 200 may be built into the head mounted display 100.

The head mounted display 100 includes a housing 150, a fitting harness 160, and headphones 170. The housing 150 houses an image display system, such as an image display element, for presenting videos to the user 300, and a wireless transfer module such as a Wi-Fi module or a Bluetooth (registered trademark) module which is not illustrated. The fitting harness 160 is used to mount the head mounted display 100 on the head of the user 300. The fitting harness 160 may be realized by, for example, a belt or an elastic band. When the user 300 wears the head mounted display 100 using the fitting harness 160, the housing 150 is arranged at a position where the eyes of the user 300 are covered. Thus, if the user 300 wears the head mounted display 100, a field of view of the user 300 is covered by the housing 150.

The headphones 170 output audio for a video that is reproduced by the gaze detection device 200. The headphones 170 may not be fixed to the head mounted display 100. Even when the user 300 wears the head mounted display 100 using the fitting harness 160, the user 300 may freely attach or detach the headphones 170. The headphones 170 are not essential.

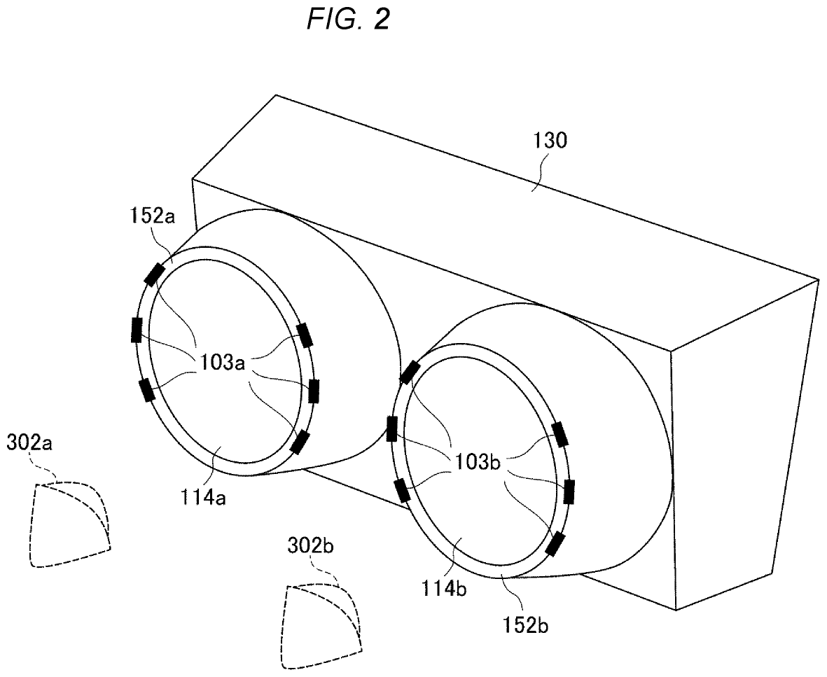

FIG. 2 is a perspective diagram illustrating an overview of the image display system 130 of the head mounted display 100 according to the embodiment. Specifically, FIG. 2 illustrates a region of the housing 150 according to an embodiment that faces corneas 302 of the user 300 when the user 300 wears the head mounted display 100.

As illustrated in FIG. 2, a convex lens 114a for the left eye is arranged at a position facing the cornea 302a of the left eye of the user 300 when the user 300 wears the head mounted display 100. Similarly, a convex lens 114b for the right eye is arranged at a position facing the cornea 302b of the right eye of the user 300 when the user 300 wears the head mounted display 100. The convex lens 114a for the left eye and the convex lens 114b for the right eye are gripped by a lens holder 152a for the left eye and a lens holder 152b for the right eye, respectively.

Hereinafter, in this specification, the convex lens 114a for the left eye and the convex lens 114b for the right eye are simply referred to as a “convex lens 114” unless the two lenses are particularly distinguished. Similarly, the cornea 302a of the left eye of the user 300 and the cornea 302b of the right eye of the user 300 are simply referred to as a “cornea 302” unless the corneas are particularly distinguished. The lens holder 152a for the left eye and the lens holder 152b for the right eye are referred to as a “lens holder 152” unless the holders are particularly distinguished.

A plurality of infrared light sources 103 are included in the lens holders 152. For the purpose of brevity, in FIG. 2, the infrared light sources that irradiate the cornea 302a of the left eye of the user 300 with infrared light are collectively referred to as infrared light sources 103a, and the infrared light sources that irradiate the cornea 302b of the right eye of the user 300 with infrared light are collectively referred to as infrared light sources 103b. Hereinafter, the infrared light sources 103a and the infrared light sources 103b are referred to as “infrared light sources 103” unless the infrared light sources are particularly distinguished. In the example illustrated in FIG. 2, six infrared light sources 103a are included in the lens holder 152a for the left eye. Similarly, six infrared light sources 103b are included in the lens holder 152b for the right eye. Thus, the infrared light sources 103 can be easily attached by not directly arranging the infrared light sources 103 in the convex lenses 114, but arranging the infrared light sources 103 in the lens holders 152 that grip the convex lenses 114. This is because machining for attaching the infrared light sources 103 is easier than for the convex lenses 114 that are made of glass or the like since the lens holders 152 are typically made of a resin or the like.

As described above, the lens holders 152 are members that grip the convex lenses 114. Therefore, the infrared light sources 103 included in the lens holders 152 are arranged around the convex lenses 114. Although there are six infrared light sources 103 that irradiate each eye with infrared light herein, the number of the infrared light sources 103 is not limited thereto. There may be at least one light source 103 for each eye, and two or more light sources 103 are desirable.

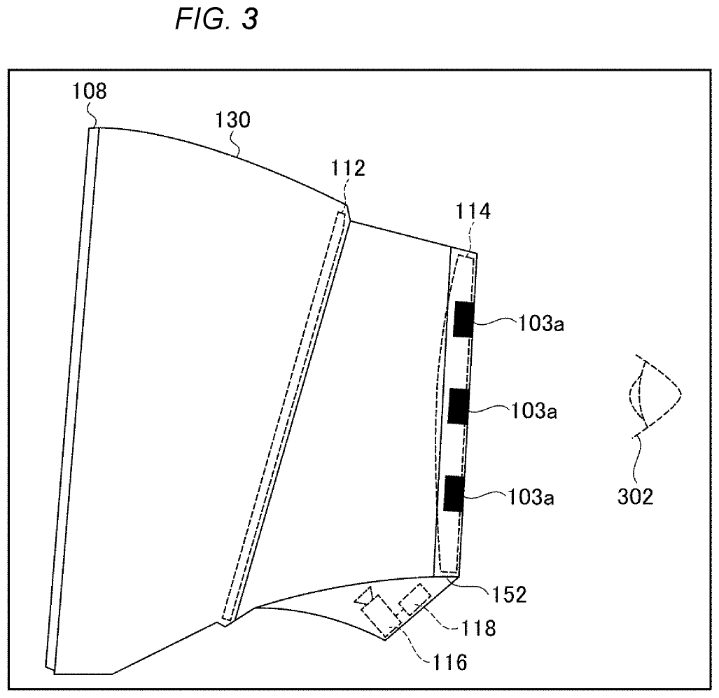

FIG. 3 is a diagram schematically illustrating an optical configuration of the image display system 130 which is housed in the housing 150 according to the embodiment and is a diagram illustrating a case in which the housing 150 illustrated in FIG. 2 is viewed from a side surface on the left eye side. The image display system 130 includes infrared light sources 103, an image display element 108, an optical device 112, a convex lens 114, a camera 116, and a communication control unit 118.

The infrared light sources 103 are light sources capable of emitting light in a near-infrared wavelength region (700 nm to 2500 nm range). Near-infrared light is generally light in a wavelength region of non-visible light that cannot be observed by the naked eye of the user 300.

The image display element 108 displays an image to be presented to the user 300. The image to be displayed by the image display element 108 is generated by a display processing unit 202 in the gaze detection device 200. The image display element 108 can be realized by using an existing liquid crystal display (LCD), an organic electro luminescence display (organic EL display), or the like.

The optical device 112 is arranged between the image display element 108 and the cornea 302 of the user 300 when the user 300 wears the head mounted display 100. The optical device 112 has a property of transmitting visible light created by the image display element 108, but reflecting near-infrared light. The optical device 112 has a property of reflecting light in a specific frequency band and examples thereof include a prism and a hot mirror.

The convex lens 114 is arranged on the opposite side of the image display element 108 with respect to the optical device 112. In other words, the convex lens 114 is arranged between the optical device 112 and the cornea 302 of the user 300 when the user 300 wears the head mounted display 100. That is, the convex lens 114 is arranged at a position facing the corneas 302 of the user 300 when the user 300 wears the head mounted display 100.

The convex lens 114 condenses image display light that is transmitted through the optical device 112. Thus, the convex lens 114 functions as an image magnifier that enlarges an image created by the image display element 108 and presents the image to the user 300. Although only one convex lens 114 is illustrated in FIG. 3 for convenience of description, the convex lens 114 may be a lens group configured by combining various lenses or may be a plano-convex lens in which one surface has curvature and the other surface is flat.

A plurality of infrared light sources 103 are arranged around the convex lens 114. The infrared light sources 103 emit infrared light toward the cornea 302 of the user 300.

Although not illustrated in the drawing, the image display system 130 of the head mounted display 100 according to the embodiment includes two image display elements 108, and can independently create an image to be presented to the right eye of the user 300 and an image to be presented to the left eye of the user. Accordingly, the head mounted display 100 according to the embodiment may present a parallax image for the right eye and a parallax image for the left eye to the right and left eyes of the user 300, respectively. Thereby, the head mounted display 100 according to the embodiment can present a stereoscopic video that has a feeling of depth to the user 300.

As described above, the optical device 112 transmits visible light but reflects near-infrared light. Thus, image light emitted by the image display element 108 is transmitted through the optical device 112, and reaches the cornea 302 of the user 300. The infrared light emitted from the infrared light sources 103 and reflected by a reflective area inside the convex lens 114 reaches the cornea 302 of the user 300.

The infrared light reaching the cornea 302 of the user 300 is reflected by the cornea 302 of the user 300 and is directed to the convex lens 114 again. This infrared light is transmitted through the convex lens 114 and is reflected by the optical device 112. The camera 116 includes a filter that blocks visible light and images the near-infrared light reflected by the optical device 112. That is, the camera 116 is a near-infrared camera which images the near-infrared light emitted from the infrared light sources 103 and reflected by the cornea of the eye of the user 300.

Although not illustrated in the drawing, the image display system 130 of the head mounted display 100 according to the embodiment includes two cameras 116, that is, a first imaging unit that captures an image including the infrared light reflected by the right eye and a second imaging unit that captures an image including the infrared light reflected by the left eye. Thereby, images for detecting gaze directions of the right eye and the left eye of the user 300 can be acquired.

The communication control unit 118 outputs the image captured by the camera 116 to the gaze detection device 200 that detects the gaze direction of the user 300. Specifically, the communication control unit 118 transmits the image captured by the camera 116 to the gaze detection device 200. Although a detection unit 203 functioning as a gaze direction detection unit will be described later in detail, the detection unit is realized by a user test image display program executed by a central processing unit (CPU) of the gaze detection device 200. When the head mounted display 100 includes computational resources such as a CPU or a memory, the CPU of the head mounted display 100 may execute the program that realizes the detection unit.

As will be described below in detail, bright spots caused by near-infrared light reflected by the cornea 302 of the user 300 and an image of the eye including the cornea 302 of the user 300 observed in a near-infrared wavelength region are captured in the image captured by the camera 116.

Although the configuration for presenting an image to the left eye of the user 300 in the image display system 130 according to the embodiment has mainly been described above, a configuration for presenting an image to the right eye of the user 300 is the same as described above.

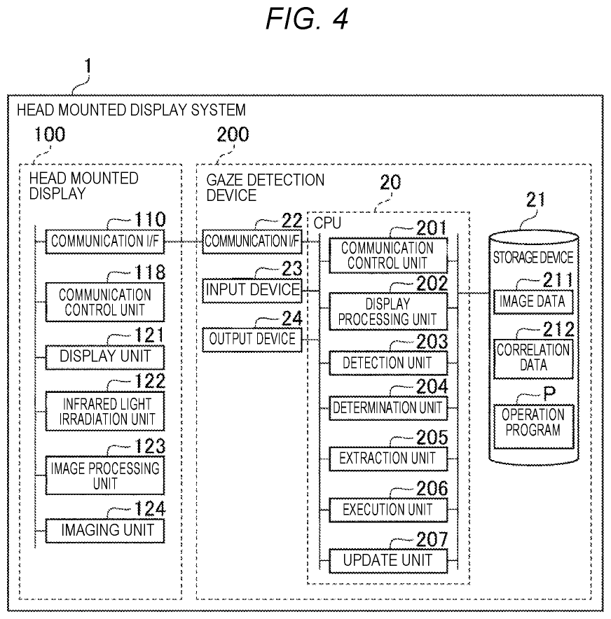

FIG. 4 is a block diagram illustrating a configuration of the head mounted display system 1 according to the embodiment. As illustrated in FIG. 4, the head mounted display 100 of the head mounted display system 1 includes a communication interface (I/F) 110, a communication control unit 118, a display unit 121, an infrared light irradiation unit 122, an image processing unit 123, and an imaging unit 124.

The communication control unit 118 controls communication with the gaze detection device 200 via the communication I/F 110. The communication control unit 118 transmits image data, which is used to detect a gaze and transmitted from the imaging unit 124 or the image processing unit 123, to the gaze detection device 200. The communication control unit 118 sends image data or a marker image transmitted from the gaze detection device 200 to the display unit 121. The image data is, for example, data for displaying a test image. The image data may be a pair of parallax images including a parallax image for the right eye and a parallax image for the left eye for displaying a three-dimensional image.

The display unit 121 has a function of displaying the image data transmitted from the communication control unit 118 on the image display element 108. The display unit 121 displays a test image as the image data. The display unit 121 displays a marker image output from the display processing unit 202 at designated coordinates on the image display element 108.

The infrared light irradiation unit 122 controls the infrared light sources 103 such that the right eye or the left eye of the user is irradiated with infrared light.

The image processing unit 123 performs image processing on the image captured by the imaging unit 124 and transmits the processed image to the communication control unit 118 if necessary.

The imaging unit 124 captures an image including near-infrared light reflected from each eye using the camera 116. The imaging unit 124 captures an image including the eye of the user viewing the marker image displayed on the image display element 108. The imaging unit 124 transmits the image acquired by imaging to the communication control unit 118 or the image processing unit 123.

As illustrated in FIG. 4, the gaze detection device 200 is an information processing device including a central processing unit (CPU) 20, a storage device 21 that stores image data 211, correlation data 212 and an operation program P, a communication I/F 22, an input device 23 such as an operation button, a keyboard, or a touch panel, and an output device 24 such as a display or a printer. In the gaze detection device 200, the CPU 20 performs functions of a communication control unit 201, a display processing unit 202, a detection unit 203, a determination unit 204, an extraction unit 205, an execution unit 206, and an update unit 207 by executing the operation program P stored in the storage device 21.

The image data 211 is data which is displayed in the head mounted display 100. The image data 211 may be a two-dimensional image or a three-dimensional image. The image data 211 may be a still image or a moving image.

The correlation data 212 is data in which a movement of a gaze is correlated with an operation signal preset depending on the movement. The operation signal may be an operation signal for performing a certain process in the head mounted display system 1. Alternatively, the operation signal may be an operation signal for performing a certain process on another device which is connected to the head mounted display system 1 via a network.

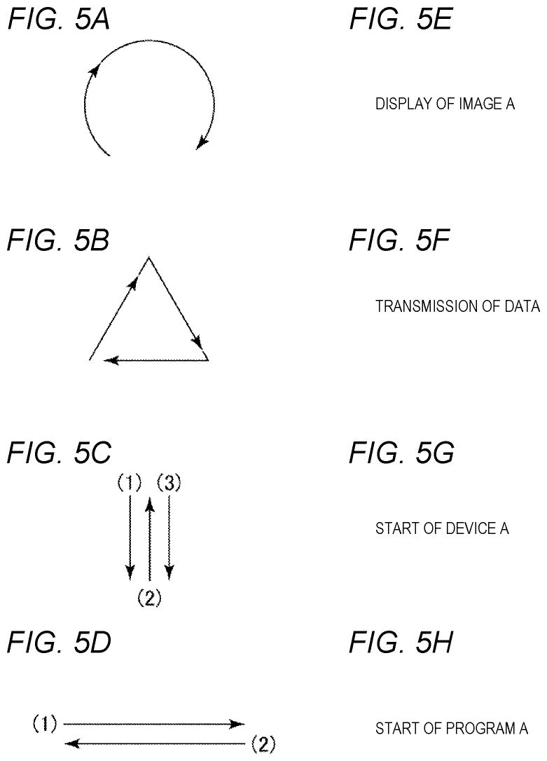

FIGS. 5A to 5D illustrate examples of predetermined movements. FIG. 5A illustrates a movement of a gaze following a circle. FIG. 5B illustrates a movement of a gaze following a regular triangle. In FIG. 5C, numerals (1) to (3) denote a sequence of movements of a gaze. Accordingly, FIG. 5C illustrates a movement of a gaze following straight lines in the order of downward, upward, and downward. In FIG. 5D, numerals (1) and (2) denote a sequence of movements of a gaze. Accordingly, FIG. 5D illustrates a movement of a gaze following straight lines in the order of rightward and leftward.

For example, in the correlation data 212, the movement of a gaze illustrated in FIG. 5A is correlated with an operation signal for displaying a specific image A in the image data 211 stored in the storage device 21. For example, in the correlation data 212, the movement of a gaze illustrated in FIG. 5B is correlated with an operation signal for transmitting data to the outside. For example, in the correlation data 212, the movement of a gaze illustrated in FIG. 5C is correlated with an operation signal for performing starting of another device A connected thereto. For example, in the correlation data 212, the movement of a gaze illustrated in FIG. 5D is correlated with an operation signal for performing starting of a program A.

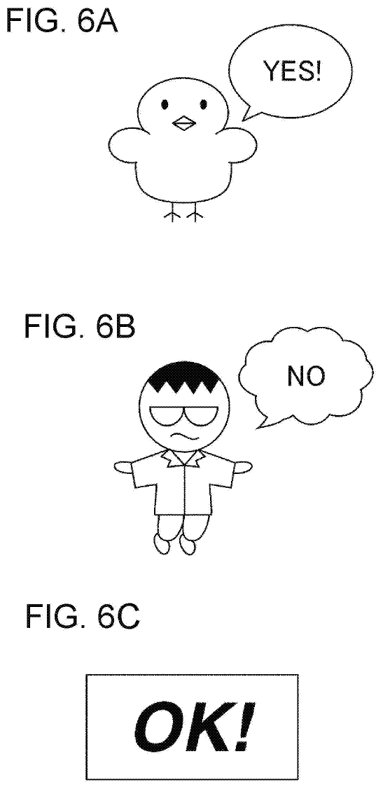

FIGS. 6A to 6C are diagrams illustrating other examples of the correlation data 212. The examples illustrated in FIGS. 6A to 6C are examples of image data to be transmitted. For example, after the movement of a gaze illustrated in FIG. 5B is detected, the image data illustrated in FIGS. 6A to 6C is displayed and an image that the user has viewed for a predetermined time or more (for example, 15 seconds or more) can be set as a target to be transmitted to another device. This image is transmitted to another device in addition to a text message or instead of a text message. The transmitted image is displayed as such a message in another device.

The communication control unit 201 controls transmission and reception of data to and from the head mounted display 100 via the communication I/F 22. When another server device or the like (not illustrated) is connected to the head mounted display system 1 via a network, the communication control unit 201 may control communication with the server device.

The display processing unit 202 displays an image on the display unit 121. Specifically, the display processing unit 202 reads image data from the storage device 21 and displays an image on the display unit 121 based thereon.

The detection unit 203 detects a gaze of the user viewing an image displayed on the display unit 121, and generates gaze data. The detection unit 203 outputs gaze data to the determination unit 204.

When the gaze data is input from the detection unit 203, the determination unit 204 reads the correlation data 212 from the storage device 21 and determines a movement of a gaze of the input gaze data among predetermined movements included in the correlation data 212. Specifically, the determination unit 204 determines which of the movements illustrated in FIGS. 5A to 5D is the movement of the user's gaze specified by the input gaze data. The movement of a gaze may be a movement other than the movements of a gaze included in the correlation data 212. In this case, the determination unit 204 cannot determine the movement of a gaze.

When an icon correlated with an operation signal is included in the image displayed on the display unit 121, it may be determined whether the movement of the user's gaze detected by the detection unit 203 is a predetermined movement taken while viewing the icon. Specifically, the determination unit 204 determines whether the user takes the movements illustrated in FIGS. 5A to 5D while viewing the icon. The determination unit 204 determines whether the user opens or closes his or her eye a predetermined number of times. In this case, in the correlation data 212, an identifier of the icon is correlated with the operation signal.

At this time, a combination of an icon and a movement of a gaze may be correlated with an operation signal instead of correlating one icon with one operation signal. It is assumed that there are icons A to E and the movements illustrated in FIGS. 5A to 5D are registered as the movements of the user's gaze. In this case, with the number of types of icons “5”×the number of types of movements of a gaze “4,” 20 types of operation signals can be registered in the correlation data 212.

When the determination unit 204 determines the movement of the user's gaze, the extraction unit 205 extracts an operation signal correlated with the movement of a gaze from the correlation data.

For example, in the correlation data 212, it is assumed that the movements illustrated in FIGS. 5A to 5D are correlated with the operation signals illustrated in FIGS. 5E and 5F. In this case, when the determination unit 204 detects the movement of the user's gaze illustrated in FIG. 5A, the extraction unit 205 extracts the operation signal for “displaying an image A.” When the determination unit 204 detects the movement of the user's gaze illustrated in FIG. 5B, the extraction unit 205 extracts the operation signal for “transmitting data.” When the determination unit 204 detects the movement of the user's gaze illustrated in FIG. 5C, the extraction unit 205 extracts the operation signal for “starting a device A.” When the determination unit 204 detects the movement of the user's gaze illustrated in FIG. 5D, the extraction unit 205 extracts the operation signal for “starting a program A.”

The execution unit 206 executes an operation corresponding to the operation signal extracted by the extraction unit 205.

After the movement correlated with the transmission of data is extracted by the extraction unit 205, it is assumed that the images illustrated in FIGS. 6A to 6C are displayed and it is detected that the user views the image illustrated in FIG. 6A for a predetermined time or more (for example, 15 seconds or more). In this case, the execution unit 206 executes a process of transmitting the image illustrated in FIG. 6A to another device in addition to a text message or instead of a text message. When it is detected that the user has viewed the image illustrated in FIG. 6B for a predetermined time or more, the execution unit 206 executes a process of transmitting the image illustrated in FIG. 6B to another device in addition to a text message or instead of a text message. When it is detected that the user has viewed the image illustrated in FIG. 6C for a predetermined time or more, the execution unit 206 executes a process of transmitting the image illustrated in FIG. 6C to another device in addition to a text message or instead of a text message. The other device displays the image transmitted from the execution unit 206 as a message.

The update unit 207 adds a correlation of a new movement of a gaze with an operation signal depending on an operation input by the user to update the correlation data 212. Specifically, the update unit 207 updates the correlation data 212 by combining an operation signal specified via the input device 23 with a movement of a gaze detected by the detection unit 203 and adding the combination as a new correlation.

The determination unit 204, the extraction unit 205, and the execution unit 206 among the units of the gaze detection device 200 may be realized by an information processing device such as an external server. When the processing units 204 to 206 are realized by an external information processing device, an acquisition unit that acquires gaze data detected by the detection unit 203 of the head mounted display system 1 is disposed in the information processing device and the determination unit 204 executes processing using the gaze data acquired by the acquisition unit.

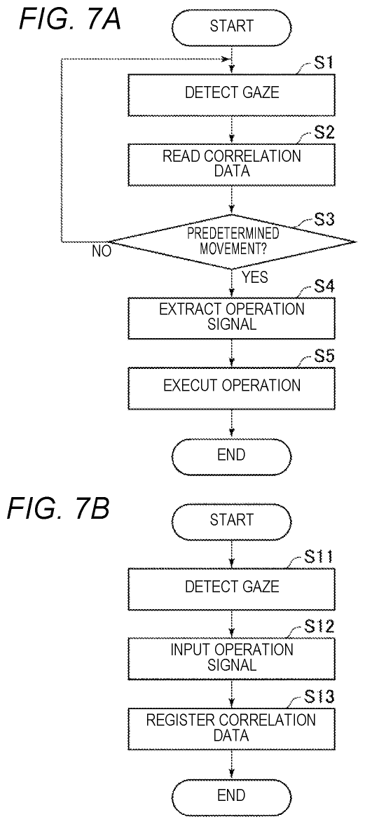

A routine of an operation method in the head mounted display system 1 will be described below with reference to the flowchart illustrated in FIG. 7A.

The head mounted display system 1 detects a user's gaze when an image is displayed on the display unit 121 (S1).

Then, the head mounted display system 1 reads the correlation data 212 from the storage device 21 (S2).

The correlation data 212 determines whether the movement of the user's gaze detected in Step S1 is a predetermined movement correlated with an operation signal in the correlation data 212 (S3).

When the detected movement is a predetermined movement (YES in Step S3), the head mounted display system 1 extracts the operation signal correlated with the movement in the correlation data 212 (S4).

Subsequently, the head mounted display system 1 executes an operation based on the operation signal extracted in Step S4 (S5).

On the other hand, when the detected movement of the user's gaze is not a predetermined movement (NO in Step S3), the routine is repeatedly performed from Step S1.

The process of updating the correlation data 212 in the head mounted display system 1 will be described below with reference to the flowchart illustrated in FIG. 7B. For example, the head mounted display system 1 can start the updating process at a time at which an operation of updating the correlation data 212 is input via the input device 23. When the operation signal for executing the updating process is registered in the correlation data 212, the head mounted display system 1 may start the updating process by detecting the movement of the gaze correlated with the operation signal for executing the registration process.

The head mounted display system 1 detects the user's gaze (S11) when the updating process is started.

The head mounted display system 1 inputs an operation signal correlated with the movement of the gaze via the input device 23 (S12). Any of the process of Step S11 and the process of Step S12 may be performed first.

Thereafter, the head mounted display system 1 updates the correlation data 212 by additionally correlating the user's gaze detected in Step S11 with the operation signal input in Step S12 (S13).

In this way, in the head mounted display system 1, by correlating a movement of a gaze with an operation signal, a user can perform an operation based on the movement of the gaze. In other words, since the user can perform various operations in a hands-free manner, it is possible to improve operability in the head mounted display system 1. The user can correlate a movement of a gaze with an operation signal and register the correlation if necessary. Accordingly, it is possible to improve operability as desired by the user as with so-called shortcut keys.

Detection of a gaze direction according to the embodiment will be described below.

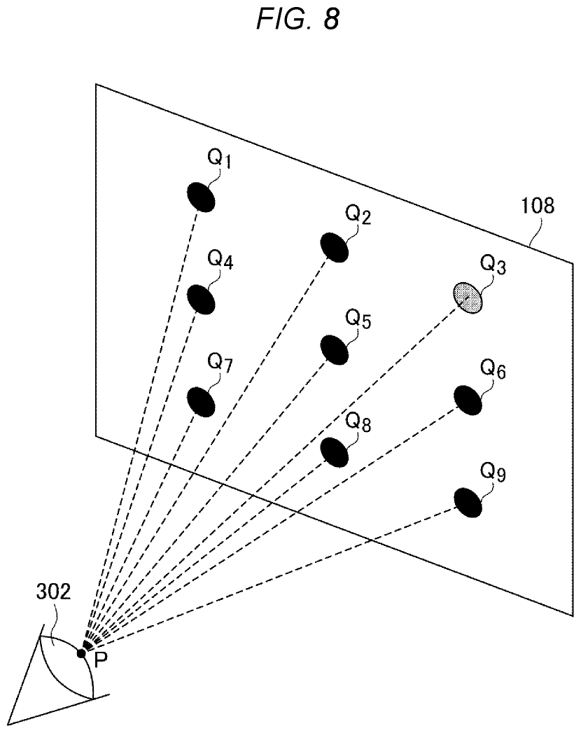

FIG. 8 is a diagram schematically illustrating calibration for detecting a gaze direction according to the embodiment. A gaze direction of the user 300 is detected by capturing an image with the camera 116 and causing the detection unit 203 in the gaze detection device 200 to analyze a video output from the communication control unit 118 to the gaze detection device 200.

The display processing unit 202 generates nine points (marker images) Q₁ to Q₉ as illustrated in FIG. 8 and displays the generated points on the image display element 108 of the head mounted display 100. The user 300 is requested to sequentially gaze at the points Q₁ to Q₉. In this case, the user 300 is requested to gaze at each of the points by moving his or her eyeballs as much as possible without moving his or her neck. The camera 116 captures images including the cornea 302 of the user 300 when the user 300 is gazing at the nine points including the points Q₁ to Q₉.

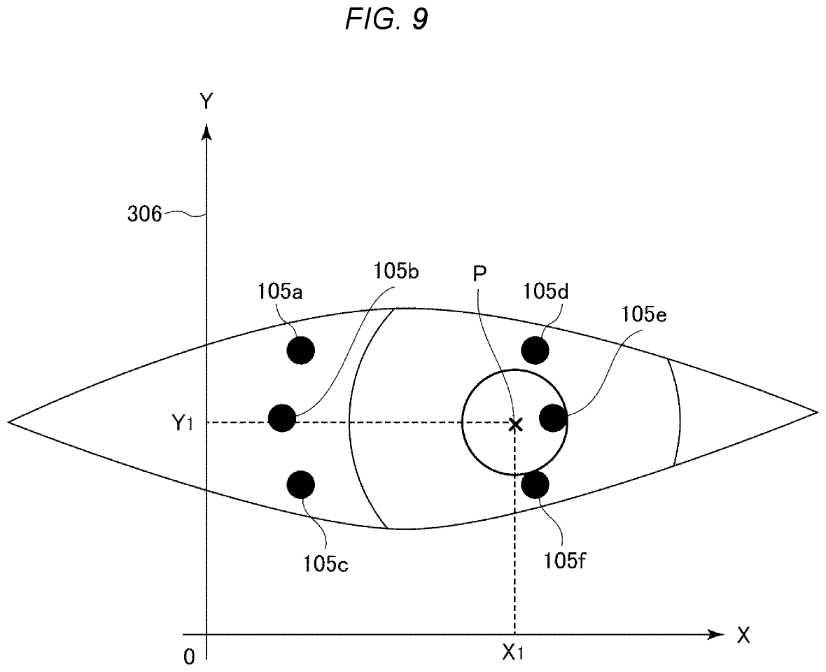

FIG. 9 is a schematic diagram illustrating the position coordinates of the cornea 302 of the user 300. The detection unit 203 in the gaze detection device 200 analyzes the images captured by the camera 116 and detects bright spots 105 derived from infrared light. When the user 300 gazes at each point by moving only his or her eyeballs, the positions of the bright spots 105 are considered to be stationary regardless of the point at which the user gazes. Thus, on the basis of the detected bright spots 105, the detection unit 203 sets a two-dimensional coordinate system 306 in the images captured by the camera 116.

The detection unit 203 detects the center P of the cornea 302 of the user 300 by analyzing the images captured by the camera 116. This is realized by using known image processing such as a Hough transform or an edge extraction process. Accordingly, the detection unit 203 can detect and acquire the coordinates of the center P of the cornea 302 of the user 300 in the set two-dimensional coordinate system 306.

In FIG. 8, the coordinates of the points Q₁ to Q₉ in the two-dimensional coordinate system set for a display screen displayed by the image display element 108 are Q₁(x₁, y₁)^{T}, Q₂(x₂, y₂)^{T}, Q₉(x₉, y₉)^{T}, respectively. The coordinates are, for example, a number of a pixel located at the center of each point. The center P of the cornea 302 of the user 300 when the user 300 gazes at the points Q₁ to Q₉ are labeled P₁ to P₉. In this case, the coordinates of the points P₁ to P₉ in the two-dimensional coordinate system 306 are P₁(X₁, Y₁)^{T}, P₂(X₂, Y₂)^{T}, . . . , P₉(X₉, Y₉)^{T}. T represents a transposition of a vector or a matrix.

A matrix M with a size of 2×2 is defined as Equation (1) below.

$$M = ( \begin{matrix}{m}_{11} & {m}_{12} \\ {m}_{21} & {m}_{22}\end{matrix} ) \qquad ( 1 )$$

In this case, if the matrix M satisfies Equation (2) below, the matrix M is a matrix for projecting the gaze direction of the user 300 onto an image plane that is displayed by the image display element 108.

P_{N}=MQ_{N}(N=1, . . . ,9) (2)

When Equation (2) is written specifically, Equation (3) below is obtained.

$$( \begin{matrix}{x}_{1} & {x}_{2} & … & {x}_{9} \\ {y}_{1} & {y}_{2} & … & {y}_{9}\end{matrix} ) = ( \begin{matrix}{m}_{11} & {m}_{12} \\ {m}_{21} & {m}_{22}\end{matrix} ) ( \begin{matrix}{X}_{1} & {X}_{2} & … & {X}_{9} \\ {Y}_{1} & {Y}_{2} & … & {Y}_{9}\end{matrix} ) \qquad ( 3 )$$

By transforming Equation (3), Equation (4) below is obtained.

$$( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) ( \begin{matrix}{m}_{11} \\ {m}_{12} \\ {m}_{21} \\ {m}_{22}\end{matrix} ) \qquad ( 4 )$$

Here,

$$y = ( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) , \\ A = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) , \\ x = ( \begin{matrix}{m}_{11} \\ {m}_{12} \\ {m}_{21} \\ {m}_{22}\end{matrix} ) \qquad$$

By the above, Equation (5) below is obtained.

y=Ax (5)

In Equation (5), elements of the vector y are known because the elements are coordinates of the points Q₁ to Q₉ that are displayed on the image display element 108 by the detection unit 203. The elements of the matrix A can be acquired because the elements are coordinates of a vertex P of the cornea 302 of the user 300. Thus, the detection unit 203 can acquire the vector y and the matrix A. A vector x that is a vector in which elements of a transformation matrix M are arranged is unknown. Accordingly, since the vector y and the matrix A are known, an issue of estimating the matrix M becomes an issue of obtaining the unknown vector x.

Equation (5) becomes a main issue to decide if the number of equations (that is, the number of points Q presented to the user 300 by the detection unit 203 at the time of calibration) is larger than the number of unknown s (that is, the number 4 of elements of the vector x). Since the number of equations is nine in the example illustrated in Equation (5), Equation (5) is the main issue to decide.

An error vector between the vector y and the vector Ax is defined as a vector e. That is, e=y−Ax. In this case, a vector xₒₚₜ that is optimal in the sense of minimizing the sum of squares of the elements of the vector e can be obtained from Equation (6) below.

xₒₚₜ=(A^{T}A)⁻¹A^{T}y (6)

Here, “−1” indicates an inverse matrix.

The detection unit 203 forms the matrix M of Equation (1) by using the elements of the obtained vector xₒₚₜ. Accordingly, by using coordinates of the vertex P of the cornea 302 of the user 300 and the matrix M, according to Equation (2), the detection unit 203 may estimate which portion of the video displayed on the image display element 108 the right eye of the user 300 is gazing at. Here, the detection unit 203 also receives information on a distance between the eye of the user and the image display element 108 from the head mounted display 100 and modifies the estimated coordinate values of the gaze of the user according to the distance information. The deviation in estimation of the gaze position due to the distance between the eye of the user and the image display element 108 may be ignored as an error range. Accordingly, the detection unit 203 can calculate a right gaze vector that connects a gaze point of the right eye on the image display element 108 to a vertex of the cornea of the right eye of the user. Similarly, the detection unit 203 can calculate a left gaze vector that connects a gaze point of the left eye on the image display element 108 to a vertex of the cornea of the left eye of the user. A gaze point of the user on a two-dimensional plane can be specified with a gaze vector of only one eye, and information in a depth direction of the gaze point of the user can be calculated by obtaining gaze vectors of both eyes. In this manner, the gaze detection device 200 may specify a gaze point of the user. The method of specifying a gaze point described herein is merely an example, and a gaze point of the user may be specified using methods other than that according to this embodiment.

The method related to gaze detection in the above embodiment is merely an example, and a gaze detection method by the head mounted display 100 and the gaze detection device 200 is not limited thereto.

First, in the above embodiment, although an example in which a plurality of infrared light sources that emit near-infrared light as invisible light are provided is given, a method of irradiating a user's eye with near-infrared light is not limited thereto. For example, each pixel that constitutes the image display element 108 of the head mounted display 100 may include sub-pixels that emit near-infrared light, and the sub-pixels that emit near-infrared light may be caused to selectively emit light to irradiate an eye of a user with near-infrared light. Alternatively, the head mounted display 100 may include a retinal projection display instead of the image display element 108 and realize near-infrared irradiation by displaying using the retinal projection display and including pixels that emit a near-infrared light color in the image projected to the retina of the user. Sub-pixels that emit near-infrared light may be regularly changed for both the image display element 108 and the retinal projection display.

The gaze detection algorithm given in the above embodiment is not limited to the method given in the above embodiment, and other algorithms may be used as long as gaze detection can be realized.

In the above embodiment, the processes in the head mounted display system 1 are described to be realized by causing the CPU 20 of the gaze detection device 200 to execute the operation program P. On the other hand, the processes may be realized using a logical circuit (hardware) or a dedicated circuit which is formed in an integrated circuit (IC) chip, a large scale integration (LSI), a field programmable gate array (FPGA), a complex programmable logic device (CPLD), or the like instead of the CPU in the gaze detection device 200. Such a circuit may be realized by one or more integrated circuits, or functions of a plurality of functional units described in the above embodiment may be realized by one integrated circuit. The LSI may be referred to as a VLSI, a super LSI, an ultra LSI, or the like depending on a difference in a degree of integration.

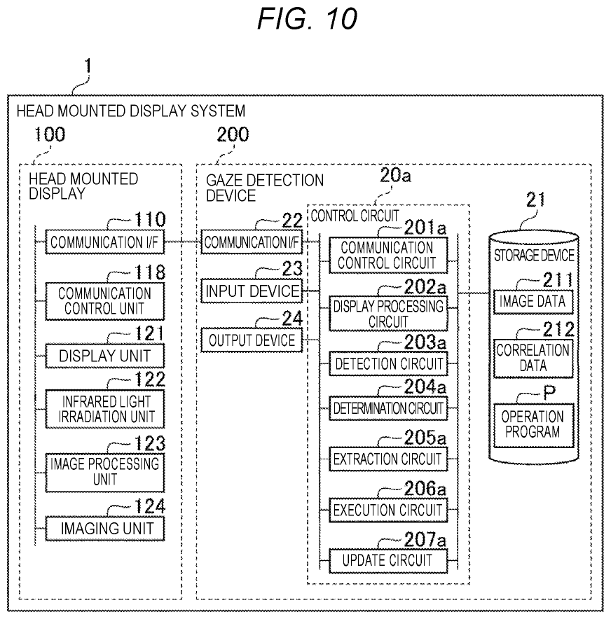

That is, as illustrated in FIG. 10, the gaze detection device 200 may include a communication I/F 22, a control circuit 20a including a communication control circuit 201a, a display processing circuit 202a, a detection circuit 203a, a determination circuit 204a, an extraction circuit 205a, and an execution circuit 206a, and a storage device 21 storing image data 211, correlation data 212, and an operation program P. The communication control circuit 201a, the display processing circuit 202a, the detection circuit 203a, the determination circuit 204a, the extraction circuit 205a, and the execution circuit 206a are controlled by the operation program P. The functions thereof are the same as those of the units having the same names described in the above embodiment.

A “non-transitory tangible medium” such as a tape, a disc, a card, a semiconductor memory, and a programmable logic circuit may be used as the storage device 21. A search program may be supplied to a processor via any transmission medium (a communication network, broadcast waves, or the like) capable of transferring the search program. The present invention can also be realized in the form of a data signal embedded in carrier waves in which an image display program is implemented by electronic transmission.

The program may be implemented using, for example, a script language such as ActionScript, JavaScript (registered trademark), Python, or Ruby, a compiler language such as C language, C++, C#, Objective-C, or Java (registered trademark), an assembly language, a register transfer level (RTL), or the like.

### Second Embodiment

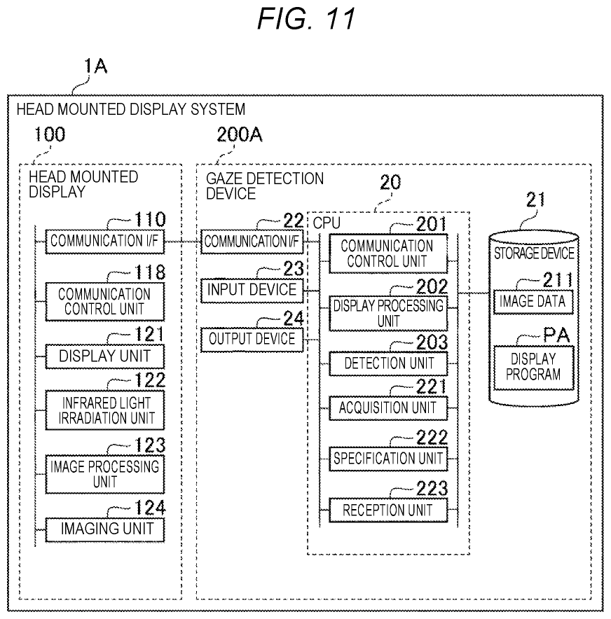

A head mounted display system 1A according to a second embodiment will be described below with reference to the block diagram illustrated in FIG. 11. The head mounted display system 1A according to the second embodiment is different from the head mounted display system 1 according to the first embodiment illustrated in FIG. 4 in that a gaze detection device 200A is provided instead of the gaze detection device 200.

The gaze detection device 200A illustrated in FIG. 11 is different from the gaze detection device 200 described above with reference to FIG. 4 in that the storage device 21 stores image data 211 and a display program PA. In the gaze detection device 200A, a CPU 20 performs processes of a communication control unit 201, a display processing unit 202, a detection unit 203, an acquisition unit 221, a specification unit 222, and a reception unit 223 by executing the display program PA stored in the storage device 21.

The display processing unit 202 can display a plurality of data groups in a display area. Here, a “display area” is, for example, an optical device 112 corresponding to a display or a range in which image data can be displayed on an optical device 112 corresponding to a display. A “data group” is a set of relevant data and is, for example, a window screen including data.

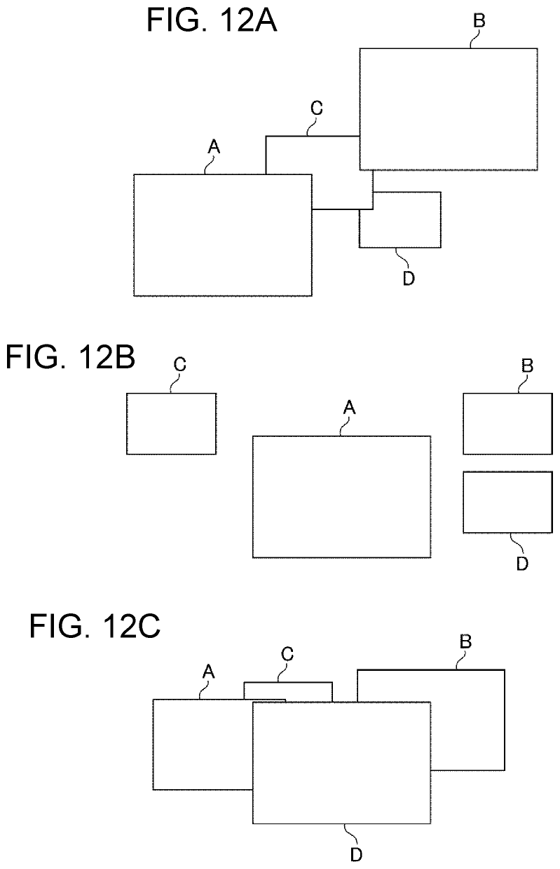

The display processing unit 202 can display a data group of interest specified by the specification unit 222 to be located at the center of the display area. For example, as illustrated in FIG. 12A, it is assumed that data group A is selected in a state in which data groups A to D are displayed. In this case, the display processing unit 202 can display the selected data group A at the center of the display area corresponding to a range of field of view of a user as illustrated in FIG. 12B. In this case, as illustrated in FIG. 12B, the display processing unit 202 can display data groups B to C other than the selected data group A around data group A.

The display processing unit 202 can display the data group of interest specified by the specification unit 222 to be larger than the other data groups in the display area. The display processing unit 202 can display the data group of interest specified by the specification unit 222 at the forefront. For example, it is assumed that data group D is selected in a state in which data groups A to D are displayed as illustrated in FIG. 12A. In this case, the display processing unit 202 can display the selected data group D to be larger than that in the pre-selection state and can display data group D displayed on the backmost surface at the forefront, as illustrated in FIG. 12C.

Here, the same is true of a case in which the examples illustrated in FIGS. 12A to 12C are displayed three-dimensionally as well as two-dimensionally. For example, when data groups A to D illustrated in FIGS. 12A to 12C are displayed in a perspective state, the selected data group is displayed at a position closest to the coordinates of the eye of the user.

The acquisition unit 221 acquires gaze data of the user viewing the display area from the detection unit 203. For example, the acquisition unit 221 acquires coordinate information of the position viewed by the user as the gaze data. The acquisition unit acquires two-dimensional position coordinates when an image displayed by the display processing unit 202 is a two-dimensional image, and acquires three-dimensional position coordinates when the image is a three-dimensional image.

The specification unit 222 specifies a data group of interest of the user from the gaze data acquired by the acquisition unit 221 among a plurality of data groups. For example, the specification unit 222 compares coordinate information of interest of the acquired gaze data with display coordinate information of data which is displayed by the display processing unit 202, and specifies the display coordinate information including the coordinate information of interest.

When the data groups are window screens, the specification unit 222 specifies a window screen which is displayed at the coordinates acquired by the acquisition unit 221 and outputs identification information of the specified window screen to the display processing unit 202. Accordingly, the selected window screen is displayed to be conspicuous to the user by the display processing unit 202. Specifically, the selected window screen is made to be conspicuous by displaying the window screen “at the center,” “in a large size,” or “at the forefront.” In this case, the display methods may be combined for display.

The reception unit 223 receives an operation signal which is input via the input device 23 by the user as an operation signal for the data group of interest specified by the specification unit 222. For example, when a specific window screen is selected and an operation of inputting text is executed by the input device 23 at that time, text is defined to be input to the window screen.

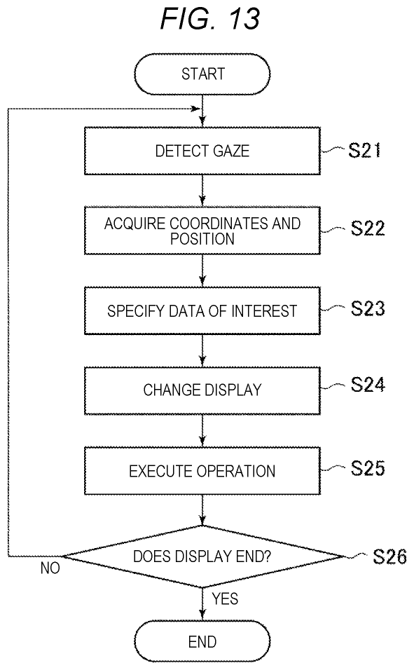

A routine of a display method in the head mounted display system 1A will be described below with reference to the flowchart illustrated in FIG. 13.

When an image is displayed on the display unit 121, the head mounted display system 1A detects a gaze of a user (S21).

Then, the head mounted display system 1A acquires a coordinate position of interest of the user (S22).

The head mounted display system 1A specifies a data group which is displayed at the coordinate position acquired in Step S22, that is, data of interest of the user (S23).

Subsequently, the head mounted display system 1A changes a display mode such that the data specified in Step S23 is conspicuous to the user (S24). For example, the specified data is made to be conspicuous to the user by displaying the data “at the center,” “in a large size,” or “at the forefront.”

The head mounted display system 1A executes an operation on the data specified in Step S23 (S25). The processing order of Steps S24 and S25 is not limited to the order illustrated in FIG. 13, but both steps may be performed at the same time or may be performed in the reverse order.

In the head mounted display system 1A, the processes of Steps S21 to S25 are repeatedly performed until display of the data ends (YES in S26).

The method of detecting a gaze direction in the head mounted display system 1A is, for example, the same as the method described above with reference to FIGS. 8 and 9 and thus description thereof will not be repeated. Although this is not described with reference to the drawings, the head mounted display system 1A may employ the control circuit including the communication control circuit, the display processing circuit, the detection circuit, the acquisition circuit, the specification circuit, and the reception circuit instead of the CPU described above with reference to FIG. 11, as described above with reference to FIG. 10.

The head mounted display system may have the configuration described above with reference to FIG. 11 in addition to the configuration described above with reference to FIG. 4, may execute an operation corresponding to gaze data, and may change a display correlation depending on the gaze data.

This invention can be used in a head mounted display.

1. An information processing system for a head mounted display, comprising:
a display that displays an image;
a camera that captures an eye of a user;
a gaze detection unit that detects a gaze of the user viewing the image;
a determination unit that determines whether the user blinked while viewing the image; and
an execution unit that executes at least one operation when the user blinked.

2. The information processing system according to claim 1, further comprising a storage device that stores a correlation data, wherein:
an icon is correlated with an operation in the correlation data,
the image includes a plurality of icons,
the determination unit determines whether the user blinked while gazing on one of the icons, and
the execution unit executes the operation correlated with the icon on which the user gazed when the user blinked.

3. The information processing system according to claim 2, wherein:
a combination of an icon and a movement of the gaze is correlated in the correlation data,
the determination unit further determines the movement of the gaze within one of the icons, and
the execution unit executes the operation correlated with the combination of one of the icons and the determined movement of the gaze.

4. The information processing system according to claim 3, wherein the movement of the gaze comprises one or more of at least one triangular movement of the gaze, and at least one sequence of opposing vertical movements of the gaze.

5. The information processing system according to claim 3, wherein after the movement of the gaze is determined, images are displayed and an image that the user has viewed for a predetermined time or more is set as a target to be transmitted to another device.

6. The information processing system according to claim 3, wherein the movement of the gaze is correlated with the operation by the user.

7. An information processing method for a head mounted display, comprising:
displaying an image on a display;
capturing an eye of a user;
detecting a gaze of the user viewing the image;
determining whether the user blinked while viewing the image; and
executing at least one operation when the user blinked.

8. The information processing method according to claim 7, further comprising storing a correlation data in a storage device, wherein:
an icon is correlated with an operation in the correlation data,
the image includes a plurality of icons,
whether the user blinked is determined while gazing on one of the icons, and
at least one operation is correlated with the icon on which the user gazed when the user blinked.

9. The information processing method according to claim 8,
wherein a combination of an icon and a movement of the gaze is correlated in the correlation data,
the method further comprising determining the movement of the gaze within the one of the icons, and
wherein the operation is correlated with the combination of the one of the icons and the determined movement of the gaze.

10. The information processing method according to claim 9, wherein the movement of the gaze comprises one or more of at least one triangular movement of the gaze, and at least one sequence of opposing vertical movements of the gaze.

11. The information processing method according to claim 9, wherein after the movement of the gaze is determined, images are displayed and an image that the user has viewed for a predetermined time or more is set as a target to be transmitted to another device.

12. The information processing method according to claim 9, wherein the movement of the gaze is correlated with the operation by the user.

13. A non-transitory computer readable storage medium storing a computer program for operating a head mounted display, the program causing a processor to perform:
displaying an image on a display;
capturing an eye of a user;
detecting a gaze of the user viewing the image;
determining whether the user blinked while viewing the image; and
executing at least one operation when the user blinked.

14. The non-transitory computer readable storage medium according to claim 13, the program further causing the processor to perform storing a correlation data in a storage device, wherein:
an icon is correlated with an operation in the correlation data,
the image includes a plurality of icons,
whether the user blinked is determined while gazing on one of the icons, and
at least one operation is correlated with the icon on which the user gazed when the user blinked.

15. The non-transitory computer readable storage medium according to claim 14,
wherein a combination of an icon and a movement of the gaze is correlated in the correlation data,
the method further comprising determining the movement of the gaze within the one of the icons, and
wherein the operation is correlated with the combination of one of the icons and the determined movement of the gaze.

16. The non-transitory computer readable storage medium according to claim 15, wherein the movement of the gaze comprises one or more of at least one triangular movement of the gaze, and at least one sequence of opposing vertical movements of the gaze.

17. The non-transitory computer readable storage medium according to claim 15, wherein after the movement of the gaze is determined, images are displayed and an image that the user has viewed for a predetermined time or more is set as a target to be transmitted to another device.

18. The non-transitory computer readable storage medium according to claim 15, wherein the movement of the gaze is correlated with the operation by the user.
